(19) United States
(12) Patent Application Publication
(10) Pub. No.: US 2004/0091344 A1
(43) Pub. Date: May 13, 2004

(54) Lifting and moving apparatus for a vehicle bed

(75) Inventors: Thomas G. Balkins, Plymouth, MN (US); Marvin Daniel Sorge, Baldwin, ND (US)

Correspondence Address: MERCHANT & GOULD PC, P.O. BOX 2903, MINNEAPOLIS, MN, 55402-0903, US

(73) Assignee: Innovative Steel Products, Inc.

(21) Appl. No.: 10/291,967

(22) Filed: Nov. 12, 2002

(51) Int. Cl. B60P 1/02

(52) U.S. Cl. 414/495

(57) ABSTRACT

The present invention is an easy to use method and apparatus for lifting and moving a load on vehicle. The lifting and moving apparatus includes a support member, a lift rail capable of moving relative to the support member, and a lift assembly that raises the lift rail vertically relative to the support member. The lift assembly also includes lift surfaces, such as rollers, that facilitate horizontal movement of the lift rail relative to the support member.

### FIELD OF THE INVENTION

The present invention relates to a lifting and moving apparatus and a method of using the same, and more specifically relates an apparatus for lifting and moving a load on a bed of a vehicle.

### BACKGROUND OF THE INVENTION

There are often limitations to loading and unloading a load from a vehicle. For example, some loads are loaded with a machine, such as a forklift, but must be unloaded by hand, which requires significant physical effort. Some loads must be positioned at a location on the vehicle that is difficult to reach. Time restraints in loading and unloading a load from a vehicle may also be an important consideration. Generally, it is often difficult to reposition many types of loads on a vehicle without the assistance of the initial loading device. An apparatus and method that address these and other factors associated with loading and unloading a load from a vehicle would be advantageous.

### SUMMARY OF THE INVENTION

The present invention is a method and apparatus for lifting and moving a load. The present invention is particularly useful for lifting and moving a load on a vehicle bed. The lifting and moving apparatus includes a support member, a lift rail that is capable of moving relative to the support member, and a lift assembly that raises the lift rail relative to the support member. The lift assembly also includes lift surfaces, such as rollers, that facilitate horizontal movement of the lift rail relative to the support member.

### BRIEF DESCRIPTION OF THE DRAWINGS

A more complete understanding of the invention and its advantages will be apparent from the Detailed Description taken in conjunction with the accompanying drawings, in which:

FIG. 1 is a side view of a commercial vehicle with one example of a lifting and moving apparatus of the present invention mounted to the bed of the vehicle;

FIG. 2 is a perspective view of one example of a lifting and moving apparatus of the present invention mounted to a vehicle bed;

FIG. 3 is a different perspective view of the apparatus shown in FIG. 2;

FIG. 4 is a perspective view of the lift rails shown in FIG. 2;

FIG. 5 is a close-up perspective view of a portion of the lift assembly of the apparatus shown in FIG. 2;

FIG. 6 is a perspective view of a portion of the lift assembly shown in FIG. 5 that includes lift surfaces in the form of rollers;

FIG. 7 is a perspective view of another portion of the lift assembly of FIG. 5 illustrating actuation linkage members;

FIG. 8 is a side view of the lift assembly of FIG. 5 with the lift surfaces and the lift rail in a raised position;

FIG. 9 is a side view of the lift assembly of FIG. 5 with the lift surfaces and the lift rail in a lowered position;

FIG. 10 is a cross sectional view of one example of a support member of the present invention embedded in the bed of a vehicle; and

FIG. 11 is a block diagram of controls for activating the lifting and moving apparatus of the present invention.

### DETAILED DESCRIPTION OF THE PREFERRED EMBODIMENT

The present invention provides an apparatus and method for lifting and moving a load. The lifting and moving apparatus includes a support member, a lift rail capable of moving relative to the support member, and a lift assembly that raises the lift rail vertically relative to the support member. The lift assembly includes a first actuator that raises the lift rail in a generally vertical direction, and a second actuator that moves the lift rail in a generally horizontal direction. The lifting and moving apparatus may be particularly useful for lifting and moving loads on a bed of a commercial vehicle such as a truck.

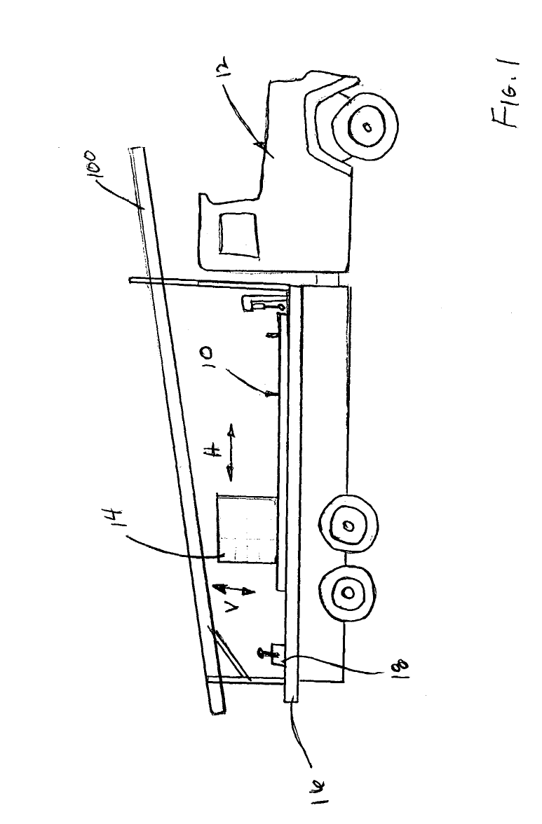

A lift apparatus 10 includes features that are examples of how certain inventive concepts of the present invention can be put into practice when mounted to a vehicle 12, as shown in FIG. 1. Vehicle 12 represents a commercial truck with a vehicle bed 16 to which lift apparatus 10 is mounted. As is typical for such a vehicle, a load 14 may be carried by the vehicle. The lift apparatus 10 may be particularly useful for lifting and moving load 10 after the load has been placed on vehicle bed 16. Lift apparatus 10 may include controls 18 that are positioned relative to lift apparatus 10 such that a user may use the controls to operate the lift apparatus.

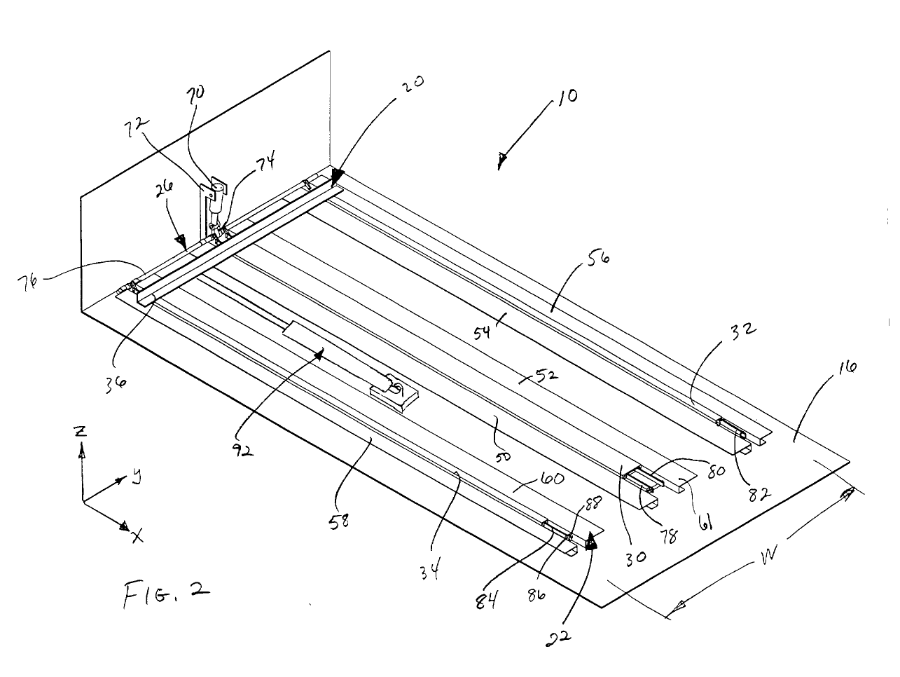

The lift apparatus 10 shown in FIG. 1 is illustrated in greater detail in the perspective view of FIG. 2, which illustrates the lift apparatus mounted to a vehicle bed 16. Lift apparatus 10 may include a lift rail assembly 20, a support member assembly 22, and a lift assembly 26. When in use, the lift assembly 26 of lift apparatus 10 functions to move the lift rail assembly 20 relative to the support member assembly 22 in such a way that a load, such as load 14 shown in FIG. 1, applied to lift apparatus 10 is moved in a vertical direction V and horizontal direction H (See FIG. 1) relative to the vehicle bed 16.

Lift rail assembly 20 is described in further detail with reference to FIGS. 2-4, 8 and 9. Lift rail assembly 20 may include a center rail 30, a first side rail 32, a second side rail 34, and a connecting rail 36. Connecting rail 36 serves as a way of connecting the lift rails together so that the lift rails move in tandem with each other in the horizontal direction. Each of the lift rails 30, 32, 34 may have a generally C-shaped cross section 38 with a primary surface 40 and side walls 42 and 43. The primary surface 40 is configured to carry a load while the side surfaces 42 and 43 facilitate positioning of the lift rails relative to the support member assembly 22 and provide containment of various features of the lift assembly 26.

In other embodiments, the lift rail assembly may have one or more lift rails depending upon the application of the lift apparatus. For example, the lift rail assembly may have three rails with the center rail being wider than the outside rails so that the lift apparatus could accommodate two loads across a width W of the lift apparatus. In other embodiments, only a single lift rail may be required to provide the necessary support required for a given load. In yet other embodiments, multiple connecting rails may be useful in providing additional support and structure for the lift rail assembly. In yet further embodiments, the cross section of the lift rails may vary, such as, for example, having a rectangular cross section or a triangular cross section so as to provide a line contact with the load rather than a surface contact provided with a C-shaped cross section shown in the Figures.

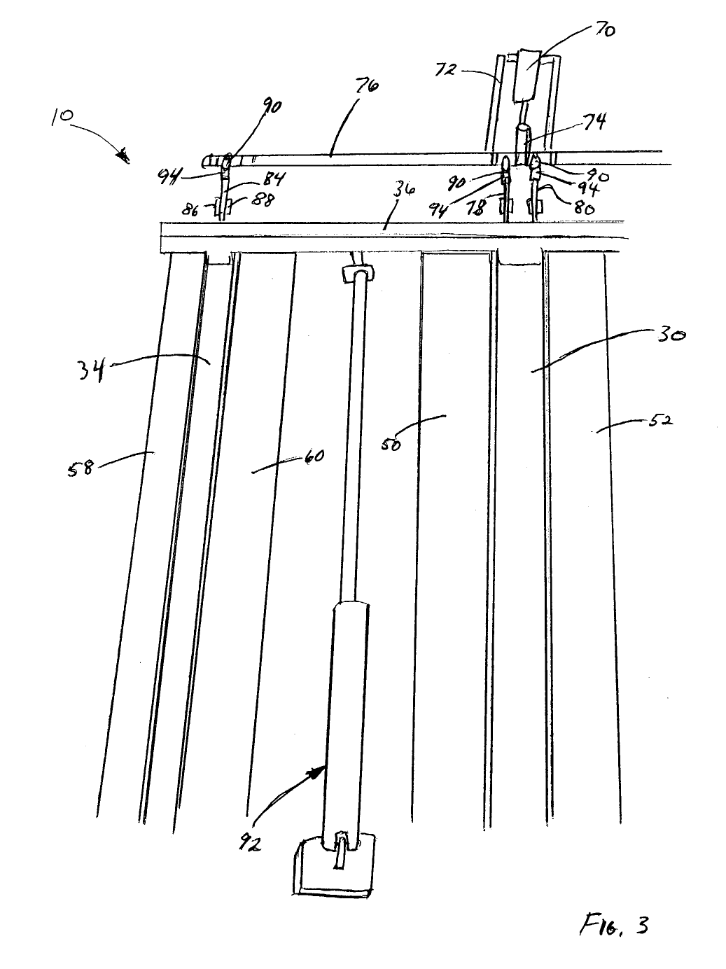

FIG. 3 illustrates the center rail 30 and first side rail 34 being positioned adjacent to and between support members 50, 52 and 58, 60, respectively. In other embodiments, the lift rails may be positioned a predetermined distance from the support members, or may be positioned adjacent a single support member while still maintaining the advantages inherent in lift apparatus 10.

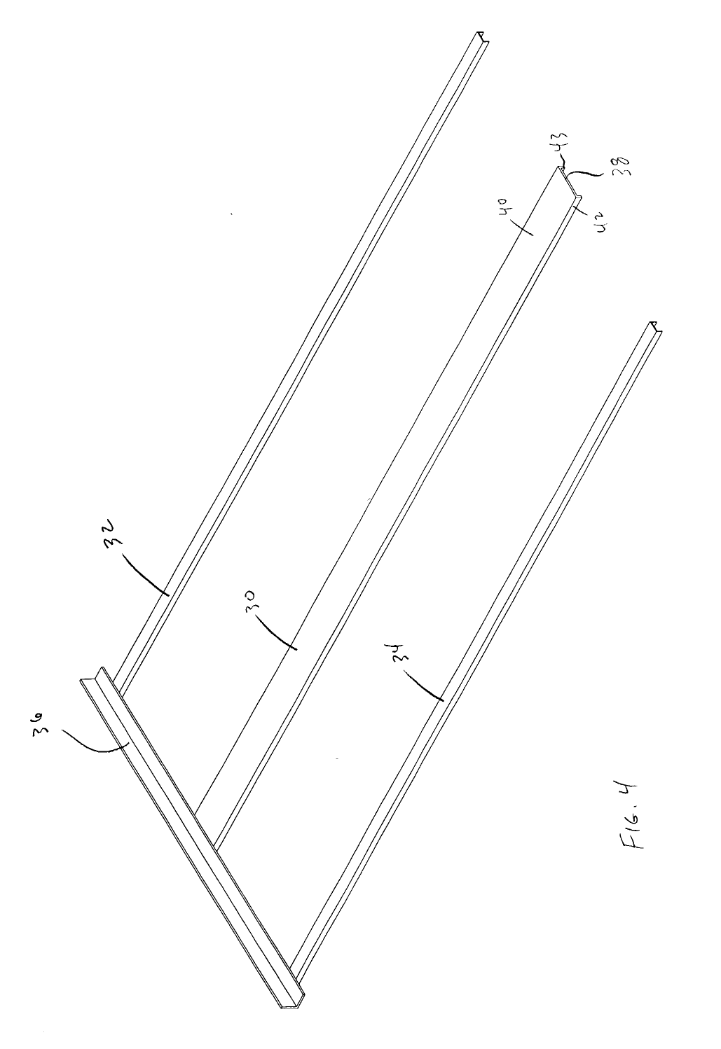

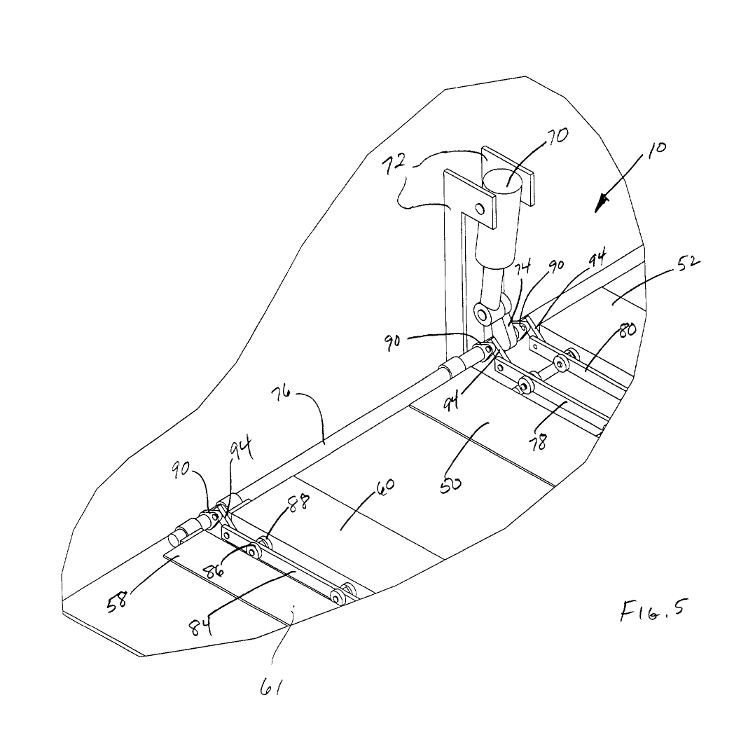

Referring now to FIGS. 2, 3, 5, 8 and 9, the support member assembly 22 is described in further detail. Support member assembly 22 includes three pairs of support members in this embodiment: first and second center support members 50, 52; first and second side support members 54, 56; and third and fourth side support members 58, 60. The support members are configured and positioned such that the lift rails 30, 32 and 34, respectively, are able to move relative to the support members, between the support members, such that the primary surface 40 of the lift rails (see FIG. 4) is able to move vertically above and below a primary surface 61 of the support members (See FIGS. 2 and 5).

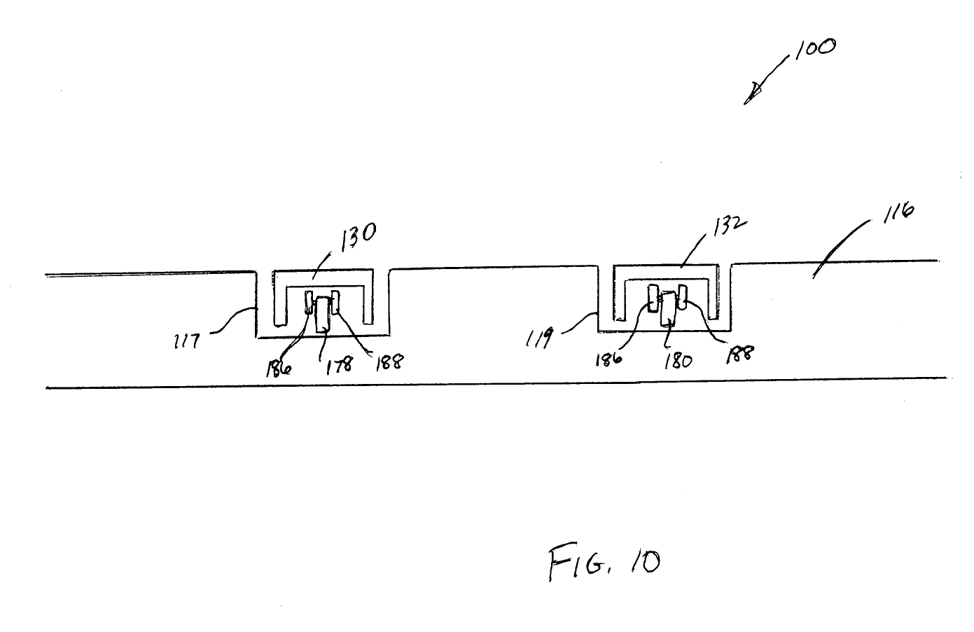

In other embodiments, the support member assembly may include a single support member that includes a recessed portion sized to receive a lift rail such that primary surface 40 of the lift rail is still able to move above and below a primary surface 61. In yet other embodiments, the support members may be built into the bed of the vehicle so that the primary surface of the support members is substantially flush with a primary load bearing surface of the vehicle bed. One example of such an embodiment is the lifting and moving apparatus 100 shown in FIG. 10. Apparatus 10 includes a vehicle bed 116 with groves 117, 119 configured for receiving lift rails 130, 132. Lift rails 130, 132 are movable relative to bed 116. Lift surfaces 186, 188 mounted to lift surface supports 178, 180, are configured to engage the lift rails 130, 132 to lift the lift rails vertically and facilitate horizontal movement of the lift rails relative to bed 116.

In a yet further embodiment, there may be support members positioned adjacent only certain lift rails. For example, only support members 56 and 58 could be used with the other support members 50, 52, 54 and 60 removed from the embodiment shown in FIG. 2. In this configuration, the load would be required to extend all the way between the support members so that lift assembly 26 can function properly to lift and move the load relative to the support members.

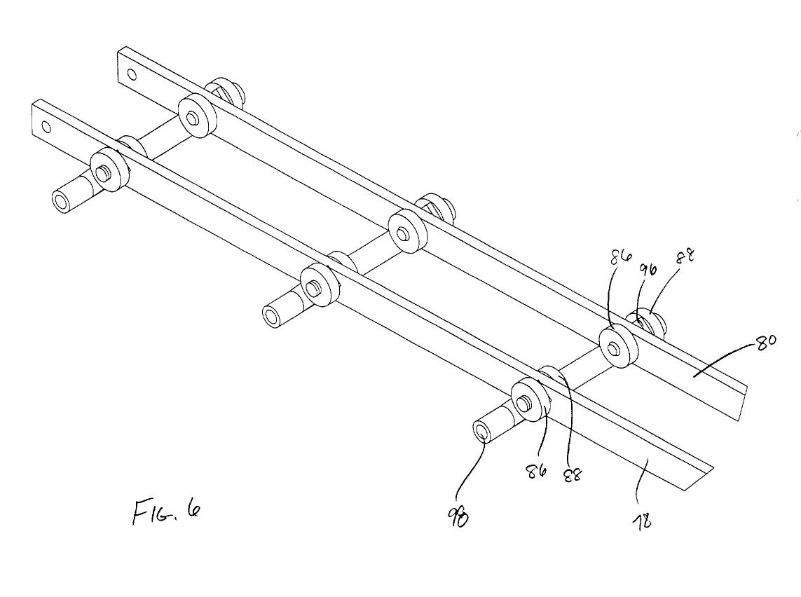

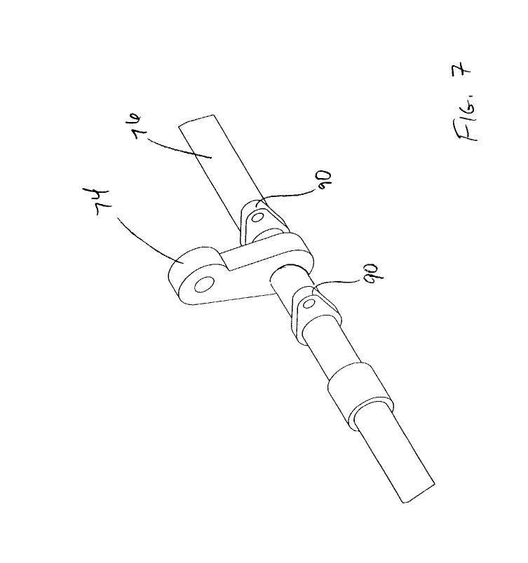

Referring now to FIGS. 2, 3 and 5-9, lift assembly 26 is described in further detail. Referring first to FIGS. 2 and 5, lift assembly 26 includes a first actuator 70, a first actuator support 72, a first link member 74, and a second link member 76, lift assembly 26 also includes first and second center lift surface supports 78 and 80, third and fourth lift surface supports 82 and 84, and first and second lift surfaces 86 and 88 mounted in pairs to each of the first, second, third and fourth lift surface supports. Lift assembly 26 further includes a third link member 90, a second actuator 92, a fourth link member 94, a fifth link member 96, and a pivot member 98 for use with fifth link member 96. Lift assembly 26 is intended to facilitate movement of the lift rail assembly in the vertical (z axis) and horizontal (x axis) directions (see FIG. 2 for xyz coordinates). By activating first actuator 70, the lift assembly engages the lift rails of the lift rail assembly 20 to move the lift rails vertically (z direction) relative to support members 50-60. By activating second actuator 92, lift rail assembly 20 moves horizontally (x direction) relative to support member assembly 22.

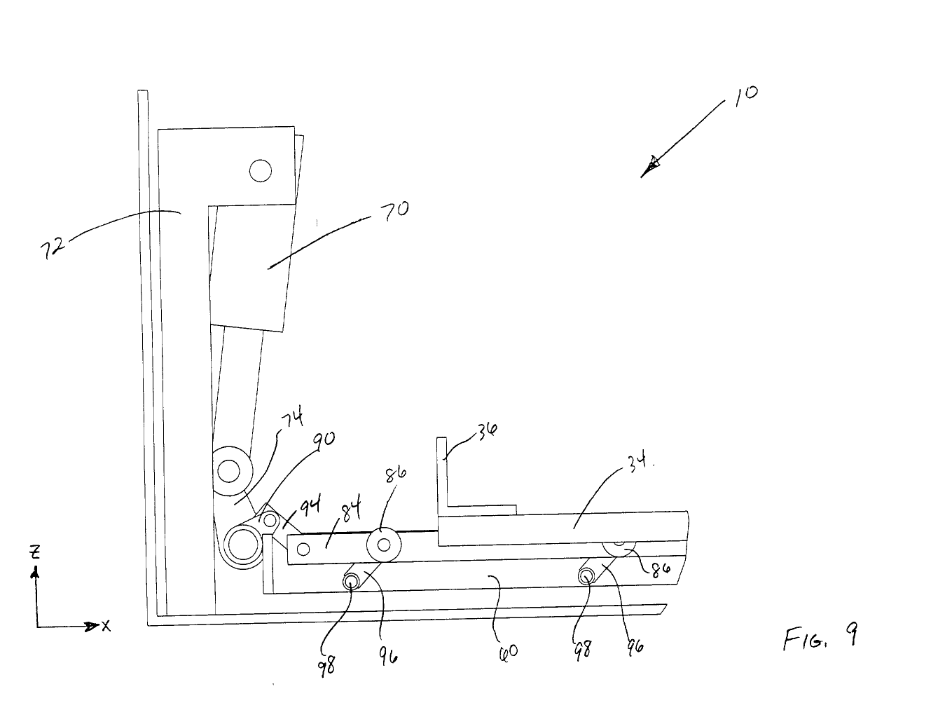

Activation of first actuator 70 causes a chain reaction of movement from the first actuator through the first, second, third, fourth and fifth link members of lift assembly 26, thereby moving the lift surfaces and consequently the lift rails. FIG. 9 illustrates the first actuator 70 in a retracted position so that the lift surface supports 78, 80, 82 and 84, with their associated pair of first and second lift surface 86 and 88, are in a first or lowered position such that the lift rail 34 is at a lowered positioned relative to the support member 60. When in the lowered position, the lift rails are capable of moving on lift surfaces 86 and 88, which are a pair of rollers in this embodiment. Thus, when a load is applied to the lift apparatus 10 with the lift surface supports and the lift rail in a lowered position, the lift rails are free to move horizontally (x direction) on lift surfaces 86 and 88 without engaging the load. The lift rails are moved horizontally by activating second actuator 92, which is secured to connecting rail 36 (See FIGS. 2 and 3). The horizontal distance lift rail assembly 20 may travel is typically limited to the difference in length between the retracted and extended positions of second actuator 92. Thus, horizontal movement of lift rail assembly 20 may vary greatly depending on the application and the specification of second actuator 92.

FIG. 10 illustrates first actuator 70 having been activated into an extended position thereby raising (x direction) the lift surface supports and the lift rails into a raised position relative to the support members of the support member assembly 22. More specifically, when first actuator 70 is activated into an extended position, first link member 74 causes second link member 76 (a rod) to rotate, thereby causing the third link members 90 to pull the lift surface support 84 into a raised position via the fourth link member 94. Lift surface support 84 is secured to fifth link member 96, which pivots about pivot member 98. In this embodiment, lift surfaces 86 and 88 are secured to lift surface support 84 at the same point at which the fifth link member 96 is secured to lift surface support 84, thus providing fewer assembly steps for lift assembly 96.

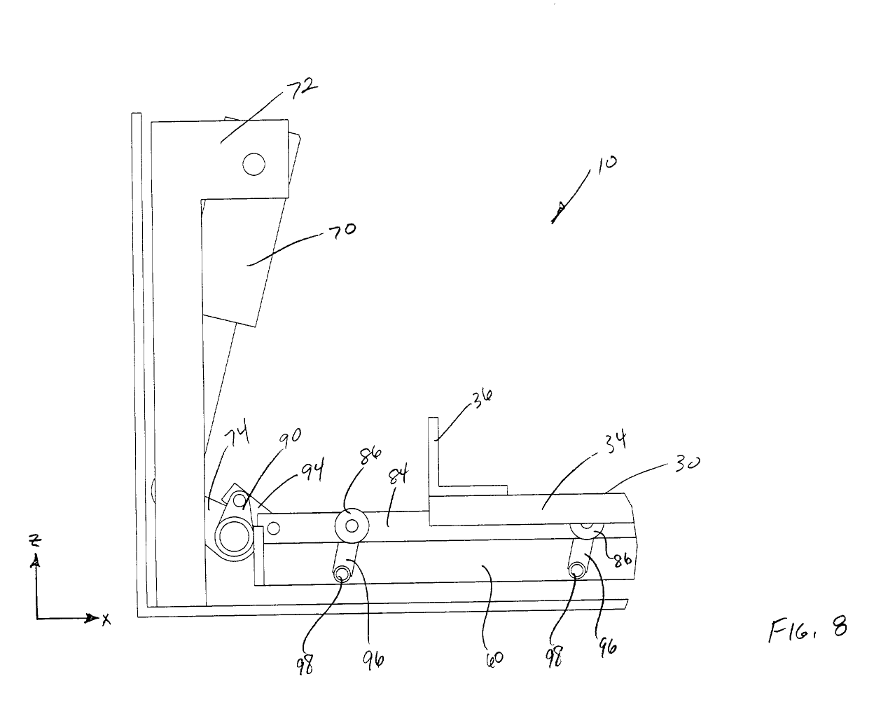

As the first actuator 70 is activated into an extended position (See FIG. 8), lift surfaces 86 and 88 contact lift rail 34, forcing the lift rail in a generally vertical direction. As a result, a primary surface 30 of the lift rail engages load 14 being supported by support members of the support assembly 22. With the lift rails in the raised position, the lift rails are capable of moving in a horizontal direction on top of lift surfaces 86 and 88 by activation of the second actuator 92. In this manner, a load may be moved from a first horizontal position relative to the support members to a second horizontal position relative to the support surfaces that is different from the first horizontal position.

After lift rail assembly 20 has moved from a first horizontal position to a second horizontal position, or visa versa, while carrying load 14, first actuator 70 may be retracted to lower lift rail assembly 20, which returns load 14 to surface 61 of the support members. With lift rail assembly 20 in the lowered position, second actuator 92 may be retracted (or extended as the case may be) to move lift rail assembly 20 back to the first horizontal position (or visa versa, as the case may be). Thus, left apparatus 10 may function through a series of movements to lift a load vertically, moving the load horizontally from a first position to a second position, lower the load, horizontally move the lift rail assembly to the first position, and repeat the cycle.

In alternative embodiments of the lift apparatus, the lift surface supports may be raised and lowered in different ways. For example, the first actuator 70 may be positioned horizontally rather than vertically while still providing the same actuation of the lift assembly via a different configuration of linkage members.

In other embodiments, the lift apparatus may be configured to lift and move a load in a slanted direction, whereby the lifting motion causes the load to move in a direction having both vertical and horizontal components, and moving the load includes movement in a direction having both vertical and horizontal components. For example, this embedment may function on a truck bed that is slanted from a horizontal direction by approximately 15 to 30 degrees.

The lift apparatus 10 of the present invention may be configured for use with a variety of different vehicles or other applications. For example, the lift apparatus 10 may be mounted to the floor of a van or trailer or may be used as part of a conveyor system in a warehouse or other commercial facility, or as part of a loading dock. Preferably, however, lift apparatus 10 is used on the bed of a flat bed truck such as the vehicle shown in FIG. 1. Lift apparatus 10 can be mounted to vehicle 12 during assembly of vehicle 12, or later, as desired by the vehicle owner, as an after-market product.

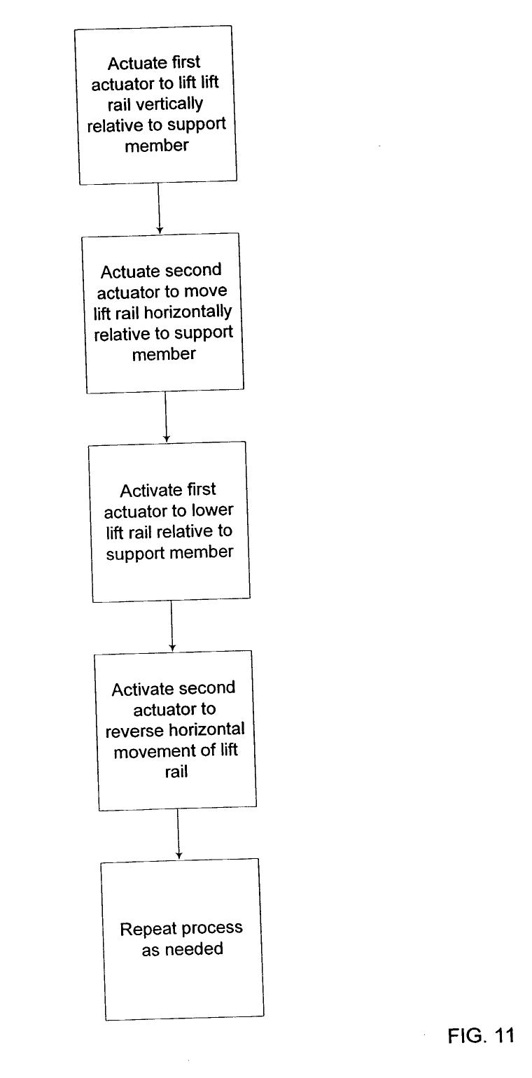

Vehicle 12 may be used is for transporting a load, such as shingles or other goods that are loaded on the bed of the vehicle with a forklift or other powered vehicle, but then must be unloaded by hand such as, for example, by placing packages of shingles onto a conveyor 100 (See FIG. 1). An operator unloading vehicle 12 may be able to use apparatus 10 to move loads positioned near a frontward position on bed 16 of the vehicle to a rearward position on bed 16 by activating controls 18. FIG. 11 is a block diagram representing general control steps of a lifting and moving apparatus of the present invention when activating controls 18.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A lift apparatus, comprising:
a support member;
a lift rail positioned adjacent the support member and capable of moving relative to the support member;
a lift assembly having lift surfaces capable of engaging the lift rail to raise the lift rail relative to the support member;
whereby the lift rail, when in the raised position, is movable on the lift surfaces.

2. The apparatus of claim 1 wherein the lift surfaces include rollers.

3. The apparatus of claim 1 wherein the lift assembly further comprises a first actuator that moves the lift surfaces from a raised position to a lowered position thereby moving the lift rail between a raised position and a lowered position.

4. The apparatus of claim 3 wherein the first actuator is configured to be manually actuated.

5. The apparatus of claim 3 wherein the actuator includes a hydraulic cylinder.

6. The apparatus of claim 3 wherein the lift assembly comprises linkages that extend between the first actuator and the lift surfaces, and extension and retraction of the first actuator causes the lift surfaces to raise and lower the lift rail.

7. The apparatus of claim 3 further comprising a second actuator that moves the lift rail between a first position and a second position that is at a different longitudinal position relative to the support member than the first position.

8. The apparatus of claim 7 wherein the second actuator is configured to be manually activated.

9. The apparatus of claim 7 wherein the second actuator includes a hydraulic cylinder.

10. The apparatus of claim 1 further comprising a first actuator that moves the lift rail vertically relative to the support member.

11. The apparatus of claim 1 further comprising a second actuator that moves the lift rail horizontally relative to the support member.

12. The apparatus of claim 1 comprising first and second lift rails that move in tandem relative to the support member.

13. The apparatus of claim 1 comprising three or more lift rails that move in tandem relative to the support member.

14. The apparatus of claim 1 wherein the support member includes a rail positioned on one or both sides of the lift rail.

15. The apparatus of claim 1 wherein the support member includes the bed of a truck.

16. The apparatus of claim 1 wherein the apparatus includes an independent unit that is capable of being mounted to the bed of a truck.

17. A method of lifting and moving, comprising:
providing a support member and a lift rail;
lifting the lift rail vertically relative to the support member from a rest position to a lifted position;
moving the lift rail horizontally relative to the support member;
lowering the lift rail to the rest position; and
reversing the horizontal movement.

18. The method of claim 17 wherein the lift rail is lifted with a lift assembly that includes rollers for engaging the lift rail, and the lift rail is horizontally movable on the rollers.

19. The method of claim 18 wherein a second actuator moves the lift rail horizontally on the rollers.

20. A lift apparatus for a truck bed, comprising:
a support member;
a lift rail capable of moving relative to the support member;
at least two rollers capable of engaging the lift rail and movable between a raised position and a lowered position;
whereby in the raised position the rollers lift the lift rail into a raised position relative to the support member, and in the lowered position the rollers enable the lift rail to reside in a lowered position relative to the support member.
